(19) United States
(12) Patent Application Publication
(10) Pub. No.: US 2025/0087093 A1
(43) Pub. Date: Mar. 13, 2025

(54) Method and Apparatus for Generating Lane Boundary in Ego-Vehicle Ground Truth System

(71) Applicant: Robert Bosch GmbH, Stuttgart (DE)

(72) Inventors: Yun Zhang, Jiangsu (CN); Shengtao Jin, Jiangsu (CN); Shouyu Wang, Jiangsu (CN)

(21) Appl. No.: 18/728,313

(22) PCT Filed: Dec. 27, 2022
(86) PCT No.: PCT/EP2022/087905

§ 371 Date: Jul. 11, 2024

(30) Foreign Application Priority Data
Jan. 29, 2022 (CN) 202210113247.9

(51) Int. Cl. G08G 1/16; G01C 21/30

(52) U.S. Cl. CPC G08G 1/167; G01C 21/30

(57) ABSTRACT

A method for generating a lane boundary in an ego-vehicle ground truth system includes (i) generating a lane boundary on the basis of received offline measurement data, (ii) predicting a position of a missing point in the lane boundary on the basis of positions of valid points in the lane boundary, and (iii) correcting and/or smoothing positions of respective points in the lane boundary on the basis of lane constraint conditions. An apparatus for generating a lane boundary in an ego-vehicle ground truth system, a computer storage medium, and a computer program product are also disclosed.

### TECHNICAL FIELD

The present invention relates to the field of generation of lane boundaries, and more particularly, to a method and apparatus for generating a lane boundary in an ego-vehicle ground truth system, a computer storage medium, and a computer program product.

### BACKGROUND

In researching and developing an intelligent driving assistance function (e.g., an ADAS lane safety function), an ego-vehicle ground truth system is typically required to verify the performance of the driving assistance function. For example, the ego-vehicle ground truth system can be used to project video lines acquired by a camera sensor (e.g., an MPC3 camera) and vehicle motion data together, and then stitch/resample video lines and points to generate a “global map”.

The ego-vehicle ground truth system is a pseudo ground truth system, and is created offline by using various data (e.g., sensor data) so as to be used for lane boundary tracking. However, this kind of pseudo ground truth system may have problems such as a missing lane boundary, etc.

### SUMMARY

According to an aspect of the present invention, provided is a method for generating a lane boundary in an ego-vehicle ground truth system, the method comprising: (step A) generating a lane boundary on the basis of received offline measurement data; (step B) predicting a position of a missing point in the lane boundary on the basis of positions of valid points in the lane boundary; and (step C) correcting and/or smoothing positions of respective points in the lane boundary on the basis of lane constraint conditions.

As an addition or alternative to the above-described solution, the method further comprises: generating a mask according to a comparison between the offline measurement data and a preset threshold.

As an addition or alternative to the above-described solution, in the method, step B comprises: positioning the missing point in the lane boundary; acquiring a forward prediction result and a backward prediction result via forward process traversal and backward process traversal, respectively; and fusing the forward prediction result and the backward prediction result to acquire the position of the missing point.

As an addition or alternative to the above-described solution, in the method, the forward process traversal or the backward process traversal comprises: a measurement update step: according to a first valid point 1_missing_prev before the missing point and on a first edge of the lane boundary, a second valid point r_exist_current opposite the missing point and on a second edge of the lane boundary, and a third valid point r_exist_prev before the second valid point and on the second edge of the lane boundary, determining a first position 1_missing_current1 of the missing point on the first edge; a prediction step: determining a second position 1_missing_current2 of the missing point on the first edge according to the first valid point 1_missing_prev and a fourth valid point 1_missing_prev_prev before the first valid point and on the first edge; and a fusion step: determining the forward prediction result or the backward prediction result by means of weighting the first position and the second position.

As an addition or alternative to the above-described solution, in the method, the first position 1_missing_current1 of the missing point is determined according to the following formula:

$$1 \_missiong \_current1 = 1 \_missing \_prev + r\_exist \_current ‐ r\_exist \_prev .$$

As an addition or alternative to the above-described solution, in the method, the second position 1_missing_current2 of the missing point is determined according to the following formula:

$$1 \_missiong \_current2 = 1 \_missing \_prev + ( 1 \_missing \_prev ‐ 1 \_missing \_prev \_prev ) .$$

As an addition or alternative to the above-described solution, in the method, the fusing the forward prediction result and the backward prediction result to acquire the position of the missing point comprises: using the forward prediction result or the backward prediction result as the position of the missing point.

As an addition or alternative to the above-described solution, in the method, the lane constraint conditions comprise a lane width constraint condition and a smoothness constraint condition.

As an addition or alternative to the above-described solution, in the method, step C comprises: correcting the lane boundary according to the lane width constraint condition; and smoothing the corrected lane boundary according to the smoothness constraint condition.

As an addition or alternative to the above-described solution, in the method, the correcting the lane boundary according to the lane width constraint condition comprises: creating a sliding window; calculating an average width of the lane boundary within the sliding window; and determining, by comparing a lane width of a first valid point in the sliding window and a lane width of a last valid point in the sliding window against the average width, whether the lane boundary needs to be corrected.

As an addition or alternative to the above-described solution, in the method, the determining, by comparing a lane width of a first valid point in the sliding window and a lane width of a last valid point in the sliding window against the average width, whether the lane boundary needs to be corrected comprises: if a difference between the lane width corresponding to the first valid point in the sliding window and the average width, and a difference between the lane width corresponding to the last valid point in the sliding window and the average width are both within a predetermined range, determining that the lane boundary does not need to be corrected; otherwise, correcting the lane boundary.

As an addition or alternative to the above-described solution, in the method, the determining, by comparing a lane width of a first valid point in the sliding window and a lane width of a last valid point in the sliding window against the average width, whether the lane boundary needs to be corrected further comprises: if the difference between the lane width corresponding to the first valid point in the sliding window and the average width, and the difference between the lane width corresponding to the last valid point in the sliding window and the average width are both out of the predetermined range, shrinking the sliding window.

As an addition or alternative to the above-described solution, in the method, the correcting the lane boundary comprises: respectively determining, on the basis of a plurality of different sliding window sizes, positions predict of a point to be corrected in the lane boundary; and fusing the plurality of positions of the point corresponding to the different sliding window sizes so as to acquire a first correction result.

As an addition or alternative to the above-described solution, in the method, the correcting the lane boundary comprises: acquiring a second correction result on the basis of historical lane point information; and fusing the first correction result, the second correction result, and a current position of the point to be corrected.

According to another aspect of the present invention, provided is an apparatus for generating a lane boundary in an ego-vehicle ground truth system, the apparatus comprising: a lane boundary generation device, for generating a lane boundary on the basis of received offline measurement data; a missing point prediction device, for predicting a position of a missing point in the lane boundary on the basis of positions of valid points in the lane boundary; and a processing device, for correcting and/or smoothing positions of respective points in the lane boundary on the basis of lane constraint conditions.

As an addition or alternative to the above-described solution, the apparatus further comprises: a mask generation device, for generating a mask according to a comparison between the offline measurement data and a preset threshold.

As an addition or alternative to the above-described solution, in the apparatus, the missing point prediction device comprises: a positioning unit, for positioning the missing point in the lane boundary; a traversing unit, for acquiring a forward prediction result and a backward prediction result via forward process traversal and backward process traversal, respectively; and a fusion unit, for fusing the forward prediction result and the backward prediction result to acquire the position of the missing point.

As an addition or alternative to the above-described solution, in the apparatus, the traversing unit is configured to: (1) perform a measurement update step, comprising: according to a first valid point 1_missing_prev before the missing point and on a first edge of the lane boundary, a second valid point r_exist_current opposite the missing point and on a second edge of the lane boundary, and a third valid point r_exist_prev before the second valid point and on the second edge of the lane boundary, determining a first position 1_missing_current1 of the missing point on the first edge; (2) perform a prediction step, comprising: determining a second position 1_missing_current2 of the missing point on the first edge according to the first valid point 1_missing_prev and a fourth valid point 1_missing_prev_prev before the first valid point and on the first edge; and (3) perform a fusion step, comprising: determining the forward prediction result or the backward prediction result by means of weighting the first position and the second position.

As an addition or alternative to the above-described solution, in the apparatus, the first position 1_missing_current1 of the missing point is determined according to the following formula:

$$1 \_missiong \_current1 = 1 \_missing \_prev + r\_exist \_current ‐ r\_exist \_prev .$$

As an addition or alternative to the above-described solution, in the apparatus, the second position 1_missing_current2 of the missing point is determined according to the following formula: 1_missiong_current2=1_missing_prev+ (1_missing_prev−1_missing_prev_prev).

As an addition or alternative to the above-described solution, in the apparatus, the fusion unit is configured to use the forward prediction result or the backward prediction result as the position of the missing point.

As an addition or alternative to the above-described solution, in the apparatus, the lane constraint conditions comprise a lane width constraint condition and a smoothness constraint condition.

As an addition or alternative to the above-described solution, in the apparatus, the processing device comprises: a correction unit, for correcting the lane boundary according to the lane width constraint condition; and a smoothing unit, for smoothing the corrected lane boundary according to the smoothness constraint condition.

As an addition or alternative to the above-described solution, in the apparatus, the correction unit is configured to: create a sliding window; calculate an average width of the lane boundary within the sliding window; and determine, by comparing a lane width of a first valid point in the sliding window and a lane width of a last valid point in the sliding window against the average width, whether the lane boundary needs to be corrected.

As an addition or alternative to the above-described solution, in the apparatus, the correction unit is configured to: if a difference between the lane width corresponding to the first valid point in the sliding window and the average width, and a difference between the lane width corresponding to the last valid point in the sliding window and the average width are both within a predetermined range, determine that the lane boundary does not need to be corrected; otherwise, correct the lane boundary.

As an addition or alternative to the above-described solution, in the apparatus, the correction unit is configured to: if the difference between the lane width corresponding to the first valid point in the sliding window and the average width, and the difference between the lane width corresponding to the last valid point in the sliding window and the average width are both out of the predetermined range, shrink the sliding window.

As an addition or alternative to the above-described solution, in the apparatus, the correction unit is configured to: respectively determine, on the basis of a plurality of different sliding window sizes, positions pₜ^{predict} of a point to be corrected in the lane boundary; and fuse the plurality of positions of the point corresponding to the different sliding window sizes so as to acquire a first correction result.

As an addition or alternative to the above-described solution, in the apparatus, the correction unit is configured to: acquire a second correction result on the basis of historical lane point information; and fuse the first correction result, the second correction result, and a current position of the point to be corrected.

According to yet another aspect of the present invention, provided is a computer storage medium, comprising an instruction, wherein when the instruction is run, the instruction performs the above method.

According to yet another aspect of the present invention, provided is a computer program product, comprising a computer program, wherein the computer program, when executed by a processor, implements the above method.

In the solution of generating a lane boundary in an ego-vehicle ground truth system according to the embodiments of the present invention, a lane boundary is constructed on the basis of finite offline measurement data, a position of a missing point in the constructed lane boundary is predicted according to positions of valid points in the lane boundary, and positions of respective points in the lane boundary are corrected and/or smoothed on the basis of lane constraint conditions. In this way, the acquired lane boundary in the ego-vehicle ground truth system has improved accuracy and reliability.

### BRIEF DESCRIPTION OF THE DRAWINGS

The foregoing and other objectives and advantages of the present invention will be made more complete and clearer from the following detailed description provided with reference to the accompanying drawings, wherein the same or similar elements use the same reference numerals.

FIG. 1 shows a schematic flowchart of a method for generating a lane boundary in an ego-vehicle ground truth system according to an embodiment of the present invention;

FIG. 2 shows a schematic structural view of an apparatus for generating a lane boundary in an ego-vehicle ground truth system according to an embodiment of the present invention;

FIG. 3 shows three cases of lane boundary missing points in an ego-vehicle ground truth system;

FIG. 4 shows, according to an embodiment of the present invention, a schematic view in which a position of a missing point in a lane boundary is predicted on the basis of positions of valid points in the lane boundary; and

FIG. 5 shows, according to an embodiment of the present invention, a schematic view in which positions of respective points in a lane boundary are corrected on the basis of lane constraint conditions.

### DETAILED DESCRIPTION

In the following, a solution for generating a lane boundary in an ego-vehicle ground truth system according to various exemplary embodiments of the present invention will be described in detail below with reference to the accompanying drawings.

FIG. 1 shows a schematic flowchart of a method 1000 for generating a lane boundary in an ego-vehicle ground truth system according to an embodiment of the present invention. As shown in FIG. 1, the method 1000 includes the following steps:
step S110, generating a lane boundary on the basis of received offline measurement data;
step S120, predicting a position of a missing point in the lane boundary on the basis of positions of valid points in the lane boundary; and
step S130, correcting and/or smoothing positions of respective points in the lane boundary on the basis of lane constraint conditions.

The term “offline measurement data” is to be distinguished from “online measurement data”. In the context of the present invention, “offline measurement data” may include a video lane boundary detection result and vehicle motion information, and is used to construct, in an offline manner, an ego-vehicle ground truth system for verifying an intelligent driving assistance function. Therefore, in step S110, the lane boundary may be generated on the basis of the received offline measurement data by means of various offline lane boundary generation algorithms (distinguished from online generation algorithms).

The term “lane boundary” in the context of the present invention may include two lane lines, i.e., left and right lane lines, and each lane line consists of a plurality of points (e.g., represented by coordinates (x, y) in an ego-vehicle coordinate system). The “lane boundary” may further include time information such as the number of sampling/measurement time periods.

However, some offline measurement data (e.g., from in-vehicle sensors such as a radar, a lidar, a video sensor, etc.) may be missing, so that the lane boundary generated in step S110, besides including valid points, may have problems such as point missing, jumping, breaking, etc.

In an embodiment, although not shown in FIG. 1, the above-described method 1000 may further include: generating a mask according to a comparison between the offline measurement data and a preset threshold. This embodiment can further ensure the accuracy and reliability of the acquired ego-vehicle ground truth system.

Specifically, the offline measurement data is finite, so that before the missing point prediction and the constraint condition-based correction, it is necessary to determine first which portions cannot be improved due to poor a priori information, so as to prevent the position of the lane boundary from being changed by blind guesses.

Thus, a mask is created, and is used to mark flaws in the ego-vehicle ground truth system. During the subsequent prediction or correction, all points within the region of the mask are set to “nan” (i.e., not a valid value).

In one or more embodiments, the mask may be generated by comparing the offline measurement data with the preset threshold. In an embodiment, the mask may be generated by comparing a video lane existence probability outputted by an MPC3 with a first threshold. In another embodiment, the mask may be generated by comparing a heading angle (and a curvature) outputted by an MPC3 with a second threshold. In yet another embodiment, the mask may be generated by comparing a lane boundary width (and a variance) with a third threshold. In yet another embodiment, the mask may be generated by comparing a lateral variation dy (variance) of left/right lane boundaries with a fourth threshold.

In addition, in order to keep the generated mask continuous, morphological operations (e.g., dilation, erosion, and closing operations, etc.) may further be performed thereon.

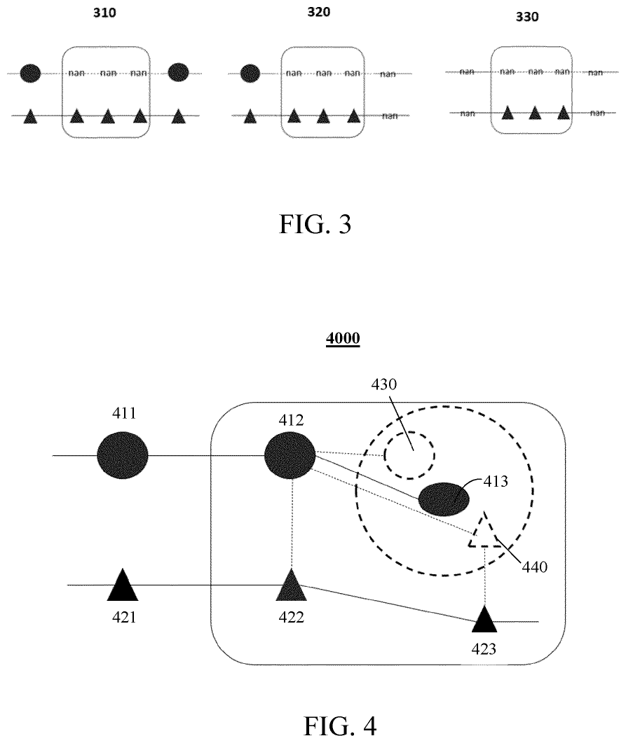

FIG. 3 shows three cases of lane boundary missing points in an ego-vehicle ground truth system. As shown in FIG. 3, 310 shows the case in which lane width information is sufficient. A solid circle represents a valid point on a first edge (e.g., the left lane line), a triangle represents a valid point on a second edge (e.g., the right lane line), and the symbol “nan” represents a missing point. 320 shows the case in which only lane width information of a single edge is sufficient. 330 shows the case in which lane width information is completely missing.

In an embodiment, step S120 includes: positioning the missing point in the lane boundary; acquiring a forward prediction result and a backward prediction result via forward process traversal and backward process traversal, respectively; and fusing the forward prediction result and the backward prediction result to acquire the position of the missing point.

In an embodiment, the positioning the missing point in the lane boundary includes: positioning a region of “missing lane points”, so as to create a virtual boundary, and locating a starting point and an end point for lane points within the boundary.

Then, the forward prediction result and the backward prediction result are acquired via the forward process traversal and the backward process traversal, respectively. Here, the “forward process” may refer to a process from the located starting point to the located end point of the lane points. Similarly, the “backward process” refers to a process from the located end point to the located starting point of the lane points.

Regarding the forward process traversal, for example, in an embodiment, the forward process traversal includes: (1) a measurement update step; (2) a prediction step; and (3) a fusion step. Specifically, the measurement update step includes: according to a first valid point 1_missing_prev before the missing point and on a first edge (e.g., the left lane line, which serves as the current work line) of the lane boundary (i.e., a valid point preceding the missing point on the current work line), a second valid point r_exist_current opposite the missing point and on a second edge (e.g., the right lane line, which serves as the reference line) of the lane boundary (i.e., a valid point opposite the missing point on the reference line), and a third valid point r_exist_prev before the second valid point and on the second edge of the lane boundary (i.e., a valid point preceding the second valid point on the reference line), determining a first position 1_missing_current1 of the missing point on the first edge. It can be understood that the backward process traversal may also include the three steps described above, but the traversing direction thereof is the exact opposite to that of the forward process.

For example, the first position 1_missing_current1 of the missing point may be determined according to the following formula: 1_missiong_current1=1_missing_prev+r_exist_current−r_exist_prev.

It can be seen that the measurement update step involves adding back a missing lane point on the basis of existing lane boundary points on the other side (e.g., the reference line). For example, if a point on the left lane line is missing, points on the right lane line may be acquired, and a distance between two points on the right lane line is added to a preceding point on the left lane line, so as to acquire a coordinate position of the missing point.

In an embodiment, the prediction step may include: determining a second position 1_missing_current2 of the missing point on the first edge according to the first valid point 1_missing_prev and a fourth valid point 1_missing_prev_prev before the first valid point and on the first edge. For example, the second position 1_missing_current2 of the missing point may be determined according to the following formula: 1_missiong_current2=1_missing_prev+(1_missing_prev−1_missing_prev_prev).

It can be seen that the prediction step actually involves adding back a missing lane point on the basis of historical lane information of the same lane line on which the missing point is located. For example, if a point on the left lane line is missing, then data is still acquired from the left lane line, and a distance between preceding points on the left lane line is added to a preceding lane point.

The fusion step involves determining the forward prediction result or the backward prediction result by means of weighting the first position and the second position. For example, a weight w1 of the first position is set to 0.6, and a weight w2 of the second position is set to 0.4, thereby acquiring the final forward prediction result.

In an embodiment, the fusing the forward prediction result and the backward prediction result to acquire the position of the missing point includes: using the forward prediction result or the backward prediction result as the position of the missing point. For example, a determination criterion may consist in which one of the forward prediction result and the backward prediction result is valid, that is, not an invalid value. The “invalid value” indicates that the missing point cannot be repaired or added back even after the forward process traversal (including the measurement update step, the prediction step, and the fusion step) or the backward process traversal described above has been performed.

FIG. 4 shows, according to an embodiment of the present invention, a schematic view 4000 in which a position of a missing point in a lane boundary is predicted on the basis of positions of valid points in the lane boundary. As shown in FIG. 4, valid points 411 and 412 are on a first edge, and valid points 421, 422, and 423 are on a second edge. A dashed circle 430 represents a second position 430 of the missing point acquired according to the prediction step, a dashed triangle 440 represents a first position 440 of the missing point acquired according to the measurement update step, and a solid circle 413 represents a result of fusing the first position 440 and the second position 430.

After step S120, missing lane points have been added back as much as possible. Then, checking can be performed to see whether the predicted lane boundary is consistent with an actual road environment. For example, valid regions (i.e., without any missing lane point) can be positioned for correction or improvement, and a start index and an end index of lane points are located. Then, these valid regions are traversed.

In an embodiment, the “lane constraint conditions” may include a lane width constraint condition and a smoothness constraint condition. For example, the lane constraint condition may be that a lane width should not change dramatically within a short distance, and the lane boundary should be smooth.

In an embodiment, step S130 includes: correcting the lane boundary according to the lane width constraint condition; and smoothing the corrected lane boundary according to the smoothness constraint condition.

Specifically, the correcting the lane boundary according to the lane width constraint condition includes: creating a sliding window (e.g., including 30 points on each of left and right sides); calculating an average width of the lane boundary within the sliding window (and a lane width of each pair of points); and determining, by comparing a lane width of a first valid point in the sliding window and a lane width of a last valid point in the sliding window against the average width, whether the lane boundary needs to be corrected.

In an embodiment, the determining, by comparing a lane width of a first valid point in the sliding window and a lane width of a last valid point in the sliding window against the average width, whether the lane boundary needs to be corrected includes: if a difference between the lane width corresponding to the first valid point in the sliding window and the average width, and a difference between the lane width corresponding to the last valid point in the sliding window and the average width are both within a predetermined range, determining that the lane boundary meets a standard and does not need to be corrected; otherwise, determining that the lane boundary needs to be corrected (e.g., by means of a forward process and a backward process). In an embodiment, if the difference between the lane width corresponding to the first valid point in the sliding window and the average width, and the difference between the lane width corresponding to the last valid point in the sliding window and the average width are both out of the predetermined range, a smaller sliding window size may be tried out.

In the forward process, for example, the correcting the lane boundary includes: respectively determining, on the basis of a plurality of different sliding window sizes, positions pₜ^{predict} of a point to be corrected in the lane boundary; and fusing the plurality of positions of the point corresponding to the different sliding window sizes so as to acquire a first correction result.

For example, the position pₜ^{predict} of the point to be corrected may be calculated by using the following formula:

$${p}_{t}^{predict} = {p}_{i - 1} + ( {p}_{i - l} - {p}_{i - windowsize} ) / ( window\_size ) ,$$

where the parameter window_size represents the sliding window size, such as 6, 9, or 13.

The plurality of positions (e.g., three positions) of the point corresponding to the different sliding window sizes may be fused by means of a triangularly weighted sum so as to acquire the first correction result. Specifically, distances between the plurality of positions are calculated so as to create a triangle, and meanwhile, the longest edge and the shortest edge are acquired. Then, a fusion factor is calculated on the basis of an edge length. For example, if the created triangle is an isosceles triangle, the fusion factor may be calculated according to the following formula:

Fusion factor Factor=disMin/factorBase, where disMin represents the edge length of the shortest edge, and factorBase may be determined on the basis of the following formula:

$$factorBase = ( dis Max + dis Min * 2 ) * ENLARGE\_Factor + 0.00001 .$$

In the above formula, disMax represents the length of the longest edge, and ENLARGE Factor is an enlargement factor, and is a constant.

If the created triangle is another type of triangle, the fusion factor may be calculated according to the following formula:

Fusion factor Factor=((factorBase−disMin)/2)/factorBase, where disMin represents the edge length of the shortest edge, and a formula for calculating factorBase is the same as that shown above, and will not be described herein again.

In an embodiment, the correcting the lane boundary includes: acquiring a second correction result on the basis of historical lane point information; and fusing the first correction result, the second correction result, and a current position of the point to be corrected.

In an embodiment, the acquiring a second correction result on the basis of historical lane point information may further includes: generating a first candidate position on the basis of a position of a preceding point i-1; generating a second candidate position on the basis of a position of a further preceding point i-2; generating a third candidate position on the basis of a position of a still further preceding point i-3; and fusing the three candidate positions by means of a triangularly weighted sum, so as to acquire the second correction result.

For example, the first candidate position XshapeLast may be determined by using the following formula:

$$XshapeLast = LaneBorder [ workSide ] [ i - 1 ] + ( LaneBorder [ refS ide ] [ i ] - LaneBorder [ refSide ] [ i - 1 ] ) ,$$

where LaneBorder [workSide] [i-1] represents a preceding point on a work side, LaneBorder [refSide] [i] represents a point corresponding to a current point to be corrected and located on a reference side, and LaneBorder [refSide] [i-1] represents a point preceding LaneBorder [refSide] [i].

For another example, the second candidate position XshapeLastLast may be determined by using the following formula:

$$XshapeLastLast = LaneBorder [ workSide ] [ i - 2 ] + ( LaneBorder [ refSide ] [ i ] - LaneBorder [ refSide ] [ i - 2 ] ) ,$$

where LaneBorder [workSide] [i-2] represents a point preceding LaneBorder [workSide] [i-1], and LaneBorder [refSide] [i-2] represents a point preceding LaneBorder [refSide] [i-1].

For another example, the third candidate position XshapeLastLastLast may be determined by using the following formula:

$$XshapeLastLastLast = LaneBorder [ workSide ] [ i - 3 ] + ( LaneBorder [ refSide ] [ i ] - LaneBorder [ refSide [ i - 3 ] ) ,$$

where LaneBorder [workSide] [i-3] represents a point preceding LaneBorder [workSide] [i-2], and LaneBorder [refSide] [i-3] represents a point preceding LaneBorder [refSide] [i-2].

Finally, the first correction result (predicted by using a plurality of sliding windows), the second correction result (created by using historical lane information), and the current position of the point to be corrected are fused (e.g., fused by means of a triangularly weighted sum).

In an embodiment, only when a difference between the fused lane point position and the current position of the point to be corrected is within a preset range, is the fused point used.

In addition, the backward process of correcting the lane boundary is similar to the forward process described above, and will not be described herein again. Finally, the correction result acquired by the forward process and the correction result acquired by the backward process may be fused by means of weighting.

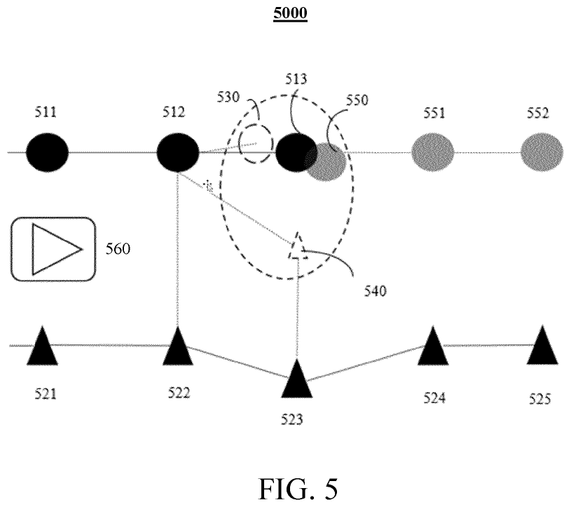

FIG. 5 shows, according to an embodiment of the present invention, a schematic view 5000 in which positions of respective points in a lane boundary are corrected on the basis of lane constraint conditions. As shown in FIG. 5, corrected points 511 and 512 are on a first edge (e.g., the left lane line, which serves as a work edge). Points 550, 551, and 552 to be corrected are also on the first edge. Valid points 521, 522, 523, 524, and 525 are on a second edge (e.g., the right lane line, which serves as a reference edge). A symbol 560 indicates a travel direction of the current vehicle.

With continued reference to FIG. 5, a first correction result 530 predicted by using a plurality of sliding windows, a second correction result 540 created by using historical lane information, and a current position 550 of a point (to be) corrected are fused, so as to acquire a corrected point 513.

In an embodiment, the smoothing the corrected lane boundary according to the smoothness constraint condition may include: positioning valid regions (i.e., without any missing lane point) on the basis of a preceding execution process of the lane width constraint condition, and locating a start index and an end index of lane points; and traversing each region, and applying savgol filtering (i.e., Savitsky-Golay filtering) to each region.

Additionally, it would be readily appreciated by those skilled in the art that the method for generating a lane boundary in an ego-vehicle ground truth system provided by one or more embodiments of the present invention may be implemented by a computer program. For example, the computer program is included in a computer program product, and when executed by a processor, the computer program implements the method for generating a lane boundary in an ego-vehicle ground truth system according to one or more embodiments of the present invention. For another example, when a computer storage medium (e.g., a USB flash drive) storing the computer program is connected to a computer, the method for generating a lane boundary in an ego-vehicle ground truth system according to one or more embodiments of the present invention can be implemented by executing the computer program.

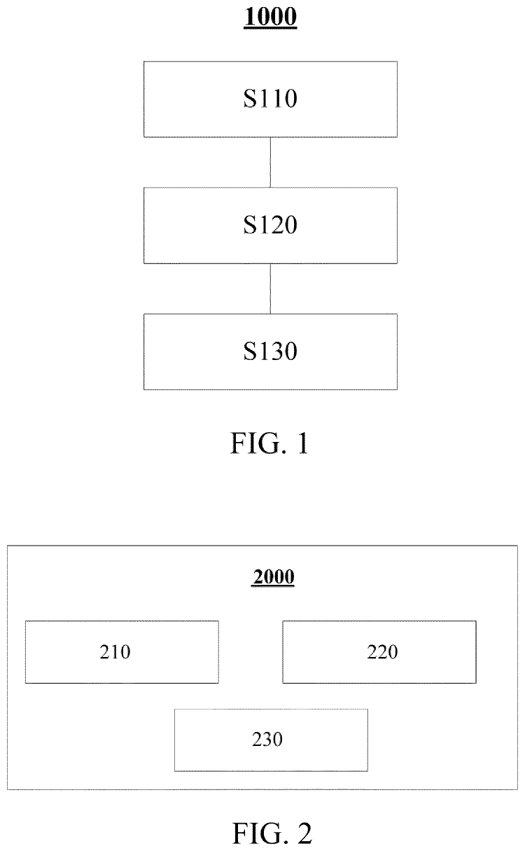

Referring to FIG. 2, FIG. 2 shows an apparatus 2000 for generating a lane boundary in an ego-vehicle ground truth system according to an embodiment of the present invention. As shown in FIG. 2, the apparatus 2000 for generating a lane boundary in an ego-vehicle ground truth system includes: a lane boundary generation device 210, a missing point prediction device 220, and a processing device 230. The lane boundary generation device 210 is for generating a lane boundary on the basis of received offline measurement data. The missing point prediction device 220 is for predicting a position of a missing point in the lane boundary on the basis of positions of valid points in the lane boundary. The processing device 230 is for correcting and/or smoothing positions of respective points in the lane boundary on the basis of lane constraint conditions.

The term “offline measurement data” is to be distinguished from “online measurement data”. In the context of the present invention, “offline measurement data” may include a video lane boundary detection result and vehicle motion information, and is used to construct, in an offline manner, an ego-vehicle ground truth system for verifying an intelligent driving assistance function. Therefore, the lane boundary generation device 210 may generate the lane boundary on the basis of the received offline measurement data by means of various offline lane boundary generation algorithms (distinguished from online generation algorithms).

The term “lane boundary” in the context of the present invention may include two lane lines, i.e., left and right lane lines, and each lane line consists of a plurality of points (e.g., represented by coordinates (x, y) in an ego-vehicle coordinate system). The “lane boundary” may further include time information such as the number of sampling/measurement time periods.

However, some offline measurement data (e.g., from in-vehicle sensors such as a radar, a lidar, a video sensor, etc.) may be missing, so that the lane boundary generated by the lane boundary generation device 210, besides including valid points, may have problems such as point missing, jumping, breaking, etc.

In an embodiment, although not shown in FIG. 2, the apparatus 2000 may further include: a mask generation device, for generating a mask according to a comparison between the offline measurement data and a preset threshold. This embodiment can further ensure the accuracy and reliability of the acquired ego-vehicle ground truth system.

Specifically, the offline measurement data is finite, so that before the missing point prediction and the constraint condition-based correction, it is necessary to determine first which portions cannot be improved due to poor a priori information, so as to prevent the position of the lane boundary from being changed by blind guesses.

Thus, a mask is created, and is used to mark flaws in the ego-vehicle ground truth system. During the subsequent prediction or correction, all points within the region of the mask are set to “nan” (i.e., not a valid value).

In one or more embodiments, the mask may be generated by comparing the offline measurement data with the preset threshold. In an embodiment, the mask generation device may generate the mask by comparing a video lane existence probability outputted by an MPC3 with a first threshold. In another embodiment, the mask generation device may generate the mask by comparing a heading angle (and a curvature) outputted by an MPC3 with a second threshold. In yet another embodiment, the mask generation device may generate the mask by comparing a lane boundary width (and a variance) with a third threshold. In yet another embodiment, the mask generation device may generate the mask by comparing a lateral variation dy (variance) of left/right lane boundaries with a fourth threshold.

In addition, in order to keep the generated mask continuous, the mask generation device may further perform morphological operations (e.g., dilation, erosion, and closing operations, etc.) thereon.

In an embodiment, the missing point prediction device 220 includes: a positioning unit, for positioning the missing point in the lane boundary; a traversing unit, for acquiring a forward prediction result and a backward prediction result via forward process traversal and backward process traversal, respectively; and a fusion unit, for fusing the forward prediction result and the backward prediction result to acquire the position of the missing point.

In an embodiment, the traversing unit is configured to: (1) perform a measurement update step, comprising: according to a first valid point 1_missing_prev before the missing point and on a first edge of the lane boundary, a second valid point r_exist_current opposite the missing point and on a second edge of the lane boundary, and a third valid point r_exist_prev before the second valid point and on the second edge of the lane boundary, determining a first position 1_missing_current1 of the missing point on the first edge; (2) perform a prediction step, comprising: determining a second position 1_missing_current2 of the missing point on the first edge according to the first valid point 1_missing_prev and a fourth valid point 1_missing_prev_prev before the first valid point and on the first edge and; and (3) perform a fusion step, comprising: determining the forward prediction result or the backward prediction result by means of weighting the first position and the second position.

In an embodiment, the fusion unit is configured to use the forward prediction result or the backward prediction result as the position of the missing point.

In one or more embodiments, the lane constraint conditions include a lane width constraint condition and a smoothness constraint condition.

In an embodiment, the processing device 230 includes: a correction unit, for correcting the lane boundary according to the lane width constraint condition; and a smoothing unit, for smoothing the corrected lane boundary according to the smoothness constraint condition.

In an embodiment, the correction unit is configured to: create a sliding window; calculate an average width of the lane boundary within the sliding window; and determine, by comparing a lane width of a first valid point in the sliding window and a lane width of a last valid point in the sliding window against the average width, whether the lane boundary needs to be corrected.

In an embodiment, the correction unit is configured to: if a difference between the lane width corresponding to the first valid point in the sliding window and the average width, and a difference between the lane width corresponding to the last valid point in the sliding window and the average width are both within a predetermined range, determine that the lane boundary does not need to be corrected; otherwise, correct the lane boundary.

In an embodiment, the correction unit is configured to: if the difference between the lane width corresponding to the first valid point in the sliding window and the average width, and the difference between the lane width corresponding to the last valid point in the sliding window and the average width are both out of the predetermined range, shrink the sliding window.

In an embodiment, the correction unit is configured to: respectively determine, on the basis of a plurality of different sliding window sizes, positions predict of a point to be corrected in the lane boundary; and fuse the plurality of positions of the point corresponding to the different sliding window sizes so as to acquire a first correction result.

In an embodiment, the correction unit is configured to: acquire a second correction result on the basis of historical lane point information; and fuse the first correction result, the second correction result, and a current position of the point to be corrected.

In conclusion, in the solution of generating a lane boundary in an ego-vehicle ground truth system according to the embodiments of the present invention, a lane boundary is constructed on the basis of finite offline measurement data, a position of a missing point in the constructed lane boundary is predicted according to positions of valid points in the lane boundary, and positions of respective points in the lane boundary are corrected and/or smoothed on the basis of lane constraint conditions. In this way, the acquired lane boundary in the ego-vehicle ground truth system has improved accuracy and reliability.

Although the above specification describes only some embodiments of the present invention, it would be appreciated by those of ordinary skill in the art that the present invention can be implemented in many other forms without departing from the spirit or scope thereof. Therefore, the illustrated examples and embodiments are regarded as illustrative and non-limiting, and the present invention may encompass various modifications and substitutions without departing from the spirit and scope of the present invention as defined by the appended claims.

1. A method for generating a lane boundary in an ego-vehicle ground truth system, comprising:
(a) generating a lane boundary on the basis of received offline measurement data;
(b) predicting a position of a missing point in the lane boundary on the basis of positions of valid points in the lane boundary; and
(c) correcting and/or smoothing positions of respective points in the lane boundary on the basis of lane constraint conditions.

2. The method according to claim 1, further comprising:
generating a mask according to a comparison between the offline measurement data and a preset threshold.

3. The method according to claim 1, wherein step (b) comprises:
positioning the missing point in the lane boundary;
acquiring a forward prediction result and a backward prediction result via forward process traversal and backward process traversal, respectively; and
fusing the forward prediction result and the backward prediction result to acquire the position of the missing point.

4. The method according to claim 3, wherein the forward process traversal or the backward process traversal comprises:
performing a measurement update step that includes determining a first position of the missing point on the first edge according to a first valid point before the missing point and on a first edge of the lane boundary, a second valid point opposite the missing point and on a second edge of the lane boundary, and a third valid point before the second valid point and on the second edge of the lane boundary;
performing a prediction step that includes determining a second position of the missing point on the first edge according to the first valid point and a fourth valid point before the first valid point and on the first edge; and
performing a fusion step that includes determining the forward prediction result or the backward prediction result by way of weighting the first position and the second position.

5. The method according to claim 4, wherein the first position of the missing point is determined according to the following formula: 1_missing_current1=1_missing_prev+r_exist_current−r_exist_prev, and
wherein 1_missing_current1 is the first position,
wherein 1_missing_prev is the first valid point,
wherein r_exist_current is the second valid point, and
wherein r_exist_prev is the third valid point.

6. The method according to claim 4, wherein the second position of the missing point is determined according to the following formula: 1_missing_current2=1_missing_prev+(1_missing_prev−1_missing_prev_prev), and
wherein 1_missing_current2 is the second position,
wherein 1_missing_prev is the first valid point, and
wherein 1_missing_prev_prev is the fourth valid point.

7. The method according to claim 3, wherein the fusing the forward prediction result and the backward prediction result to acquire the position of the missing point comprises:
using the forward prediction result or the backward prediction result as the position of the missing point.

8. The method according to claim 1, wherein the lane constraint conditions comprise a lane width constraint condition and a smoothness constraint condition.

9. The method according to claim 8, wherein step (c) comprises:
correcting the lane boundary according to the lane width constraint condition; and
smoothing the corrected lane boundary according to the smoothness constraint condition.

10. The method according to claim 9, wherein the correcting the lane boundary according to the lane width constraint condition comprises:
creating a sliding window;
calculating an average width of the lane boundary within the sliding window; and
determining, by comparing a lane width of a first valid point in the sliding window and a lane width of a last valid point in the sliding window against the average width, whether the lane boundary needs to be corrected.

11. The method according to claim 10, wherein the determining, by comparing a lane width of a first valid point in the sliding window and a lane width of a last valid point in the sliding window against the average width, whether the lane boundary needs to be corrected comprises:
if a difference between the lane width corresponding to the first valid point in the sliding window and the average width, and a difference between the lane width corresponding to the last valid point in the sliding window and the average width are both within a predetermined range, determining that the lane boundary does not need to be corrected; otherwise, correcting the lane boundary.

12. The method according to claim 11, wherein the determining, by comparing a lane width of a first valid point in the sliding window and a lane width of a last valid point in the sliding window against the average width, whether the lane boundary needs to be corrected further comprises:
if the difference between the lane width corresponding to the first valid point in the sliding window and the average width, and the difference between the lane width corresponding to the last valid point in the sliding window and the average width are both out of the predetermined range, shrinking the sliding window.

13. The method according to claim 11, wherein the correcting the lane boundary comprises:
respectively determining, on the basis of a plurality of different sliding window sizes, positions of a point to be corrected in the lane boundary; and
fusing the plurality of positions of the point corresponding to the different sliding window sizes so as to acquire a first correction result.

14. The method according to claim 13, wherein the correcting the lane boundary comprises:
acquiring a second correction result on the basis of historical lane point information; and
fusing the first correction result, the second correction result, and a current position of the point to be corrected.

15. An apparatus for generating a lane boundary in an ego-vehicle ground truth system, comprising:
a lane boundary generation device configured to generate a lane boundary on the basis of received offline measurement data;
a missing point prediction device configured to predict a position of a missing point in the lane boundary on the basis of positions of valid points in the lane boundary; and
a processing device configured to correct and/or smooth positions of respective points in the lane boundary on the basis of lane constraint conditions.

16. A computer storage medium, comprising an instruction, wherein when the instruction is run, the instruction performs the method according claim 1.

17. A computer program product, comprising a computer program, wherein the computer program, when executed by a processor, implements the method according to claim 1.
